(19) United States
(12) Patent Application Publication
(10) Pub. No.: US 2008/0097639 A1
(43) Pub. Date: Apr. 24, 2008

(54) Remote Multipoint Monitoring And Timeline Analysis Equipment

(76) Inventor: Jorge Laersion Badotti, Curitiba Parana (BR)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/719,072

(22) PCT Filed: Nov. 11, 2005
(86) PCT No.: PCT/BR05/00235

§ 371 Date: Sep. 14, 2007

(30) Foreign Application Priority Data
Nov. 11, 2004 (BR) PI 0404926-8
Nov. 10, 2005 (BR) CI 0404926-8

(51) Int. Cl. G06F 19/00

(52) U.S. Cl. 700/111; 700/108

(57) ABSTRACT

The equipment is comprised of three different modules, to with: control unit (UC), one or more retransmission units (HUBs) and, sensor units (Uss) with sensors. Initially, the device is meant for automated, real time analysis of time lines of manufacturing processes where there is interaction between operators and machines in the garment sector. It is also perfectly applicable to any repetitive production process, where there is interaction between people and machines that are not totally automated, and, therefore, the majority of small and medium-sized industrial ventures. A PC (5) is connected to the control unit (UC)(I) that, in its turn, connects to one or more retransmission units (HUBs) (2). Each HUB connects to up to 16 sensor units (Uss (3), capable of receiving input from up to 3 sensors (4), that will be installed on all production machines. The enhancement developed and added to the patent consists in the innovations introduced in it through the algorithms deployed in the method for remote multipoint monitoring and timeline analysis.

This patent of invention document refers to the “Remote Multipoint Monitoring and Timeline Analysis Equipment”, that is linked to a PC (5), and is comprised of three different modules, to with: the control unit (UC), one or more retransmission units (HUBs) and, sensor units (USs) with the respective sensors.

The “Remote Multipoint Monitoring and Timeline Analysis Equipment” is meant for real time automated timeline analysis for manufacturing processes in the garment sector where there is interaction between operators and machines. It can also be perfectly applied to any repetitive production process, with interaction between people and not fully automated machines, and, therefore, the vast majority of small and medium sized industrial ventures.

The control unit (UC) is connected to a PC (5) through a serial port that, in its turn, connects through a network comprised of cables with two twisted pairs and RJ11 connectors, to one or more retransmission units (HUBs). Each HUB can handle up to 16 sensor units (USs), with capacity for up to 3 sensors, which are installed on production machines.

Basically, the retransmission unit (HUB) has 2 ports for the primary network, one that serves as connection to a control unit (UC) and the other, to another retransmission unit (HUB) for network increase purposes. The HUB also offers 16 ports that form the secondary network, and where the sensor units (USs) are connected.

The current state of technical development offers the garment sector machines that perform totally automated operations and, for this reason, are extremely expensive, with their application being limited to large-scale industries.

There are also machines with low level automation, used by small and medium sized industrial ventures, where the operator has a major influence in the process, and the association of an operator acting on a machine generates low level repeatability and reproducibility for the production process. For this type of equipment there is no device available that delivers, in real time, data for automatic timeline analysis.

For manual machines, or any association of these with automatic microprocessor controlled machines, there is need to resort to manual data input methods on spreadsheets for manual time takings. Production volumes must then undergo accurate analysis for each machine (timeline analysis), adjusting production lines manually so as to avoid “bottlenecks” or generating idle time for extremely costly machines.

Timeline analysis means:
Plan for developing efficiency;
Operator times and movement studies;
Control of plant and operator production potential, informing operators and production supervision of the output in relation to targets;
Study of production targets as a function of pilot part assembly and production history;
Studies for production layout improvement.

For a better understanding of this patent of invention, a detailed description is given below of the remote multipoint monitoring and timeline analysis equipment referenced to the attached drawings, with:

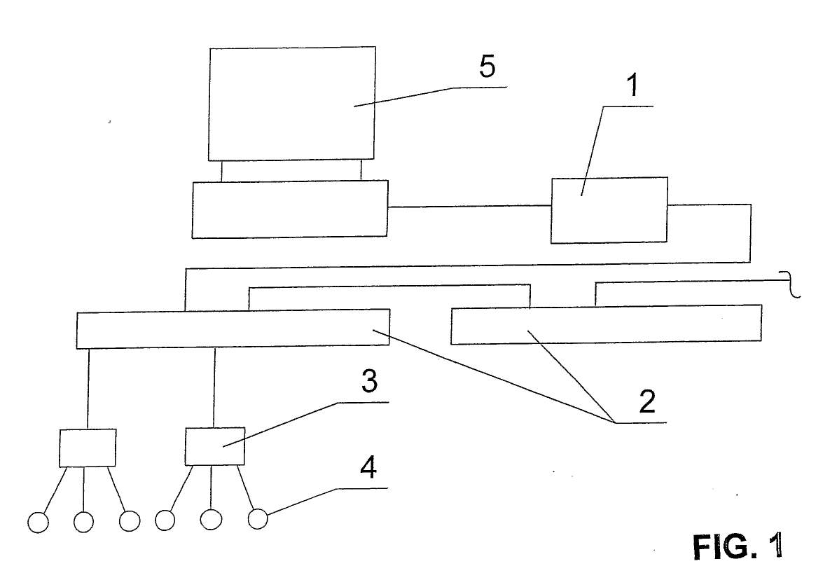

FIG. 1 shows for the patent of invention “Remote Multipoint Monitoring and Timeline Analysis Equipment”, the overall schematics diagram.

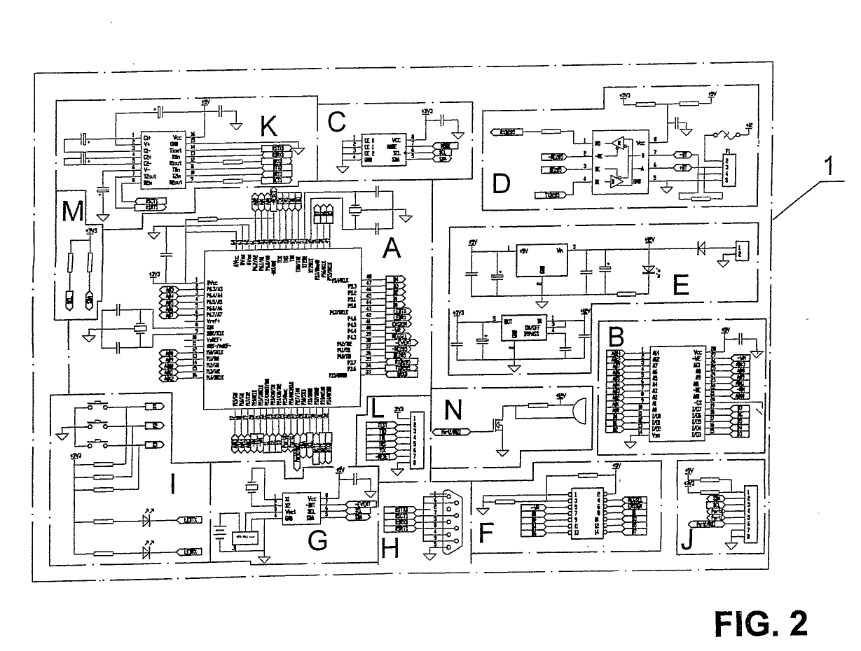

FIG. 2 shows for the patent of invention “Remote Multipoint Monitoring and Timeline Analysis Equipment”, the electric wiring diagram for the board of the control unit (UC).

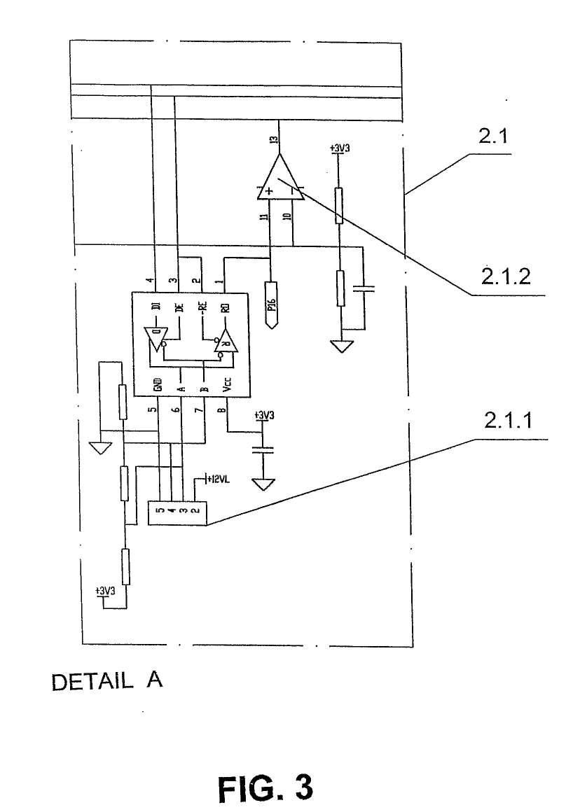

FIG. 3 shows for the patent of invention “Remote Multipoint Monitoring and Timeline Analysis Equipment”, detail A of the electric wiring diagram for the board of the control unit (UC), FIG. 2.

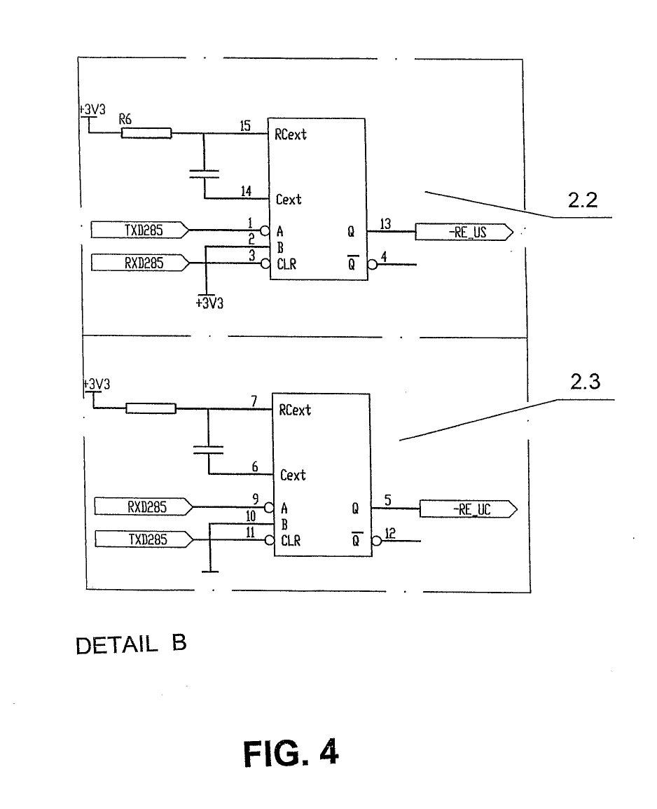

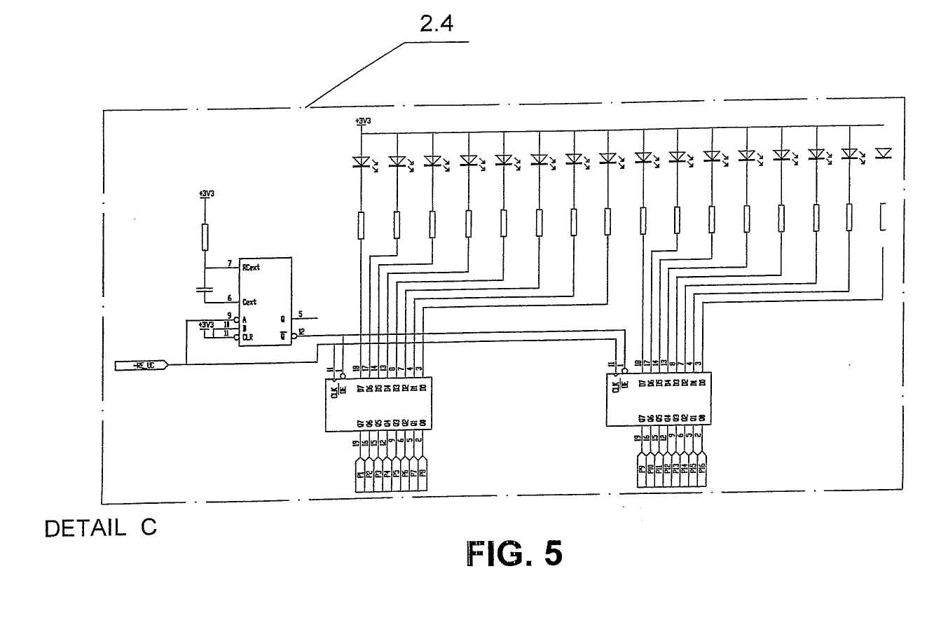

FIG. 4 shows for the patent of invention “Remote Multipoint Monitoring and Timeline Analysis Equipment”, detail B of the electric wiring diagram for the control unit (UC), FIG. 2.

FIG. 5 shows for the patent of invention “Remote Multipoint Monitoring and Timeline Analysis Equipment”, detail C of the electric wiring diagram for the control unit (UC), FIG. 2.

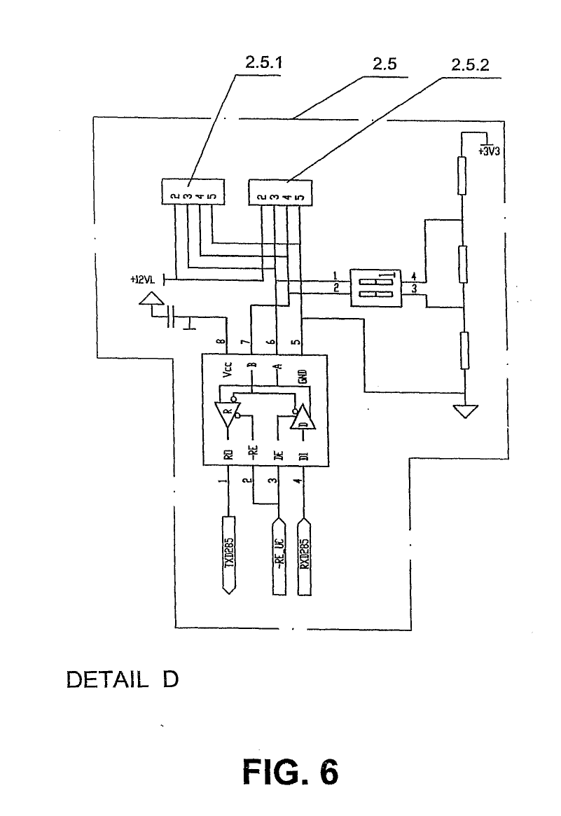

FIG. 6 shows for the patent of invention “Remote Multipoint Monitoring and Timeline Analysis Equipment”, detail D of the electric wiring diagram for the control unit (UC), FIG. 2.

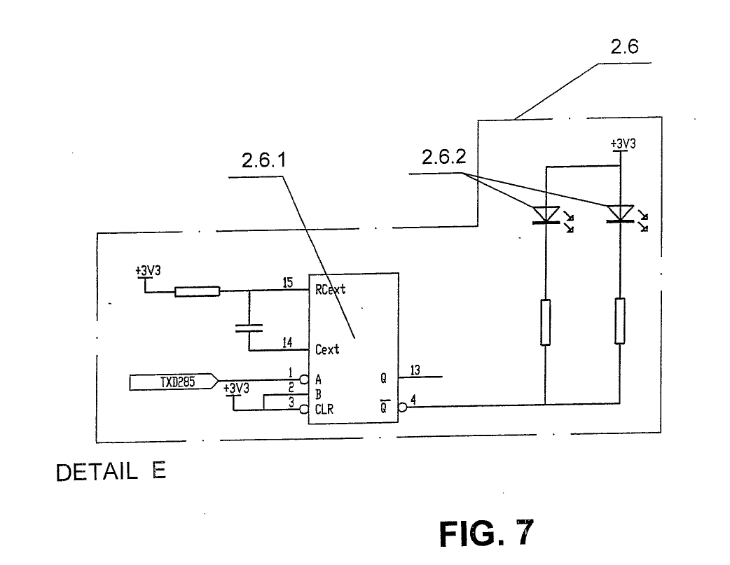

FIG. 7 shows for the patent of invention “Remote Multipoint Monitoring and Timeline Analysis Equipment”, detail E of the electric wiring diagram for the control unit (UC), FIG. 2.

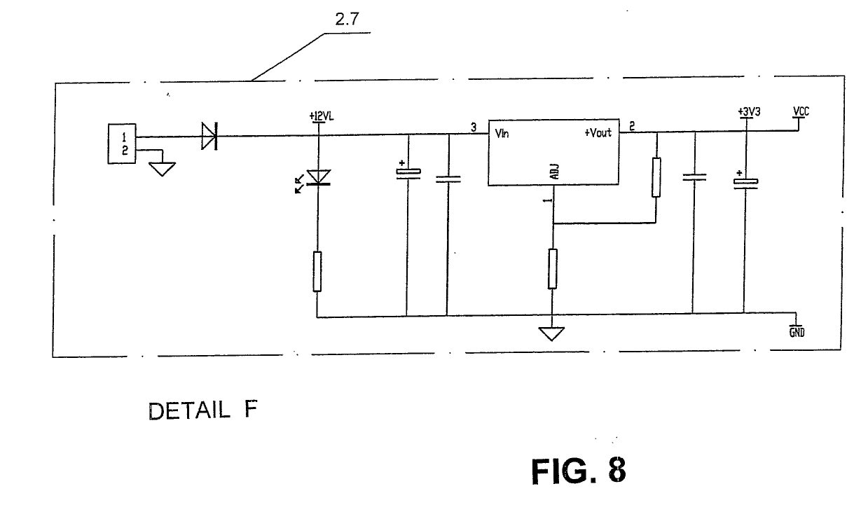

FIG. 8 shows for the patent of invention “Remote Multipoint Monitoring and Timeline Analysis Equipment”, detail F of the electric wiring diagram for the control unit (UC), FIG. 2.

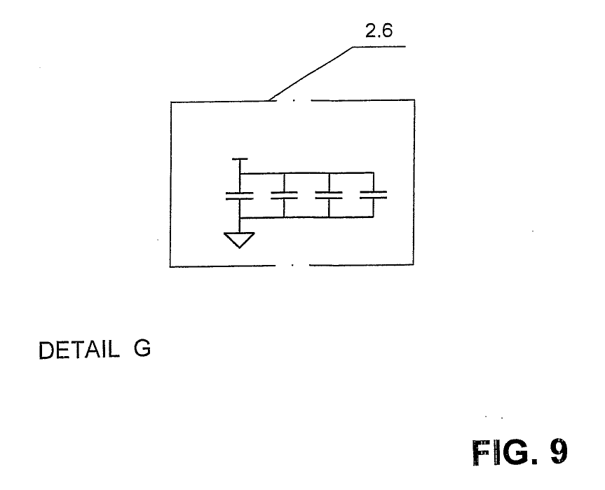

FIG. 9 shows for the patent of invention “Remote Multipoint Monitoring and Timeline Analysis Equipment”, detail G of the electric wiring diagram for the control unit (UC), FIG. 2.

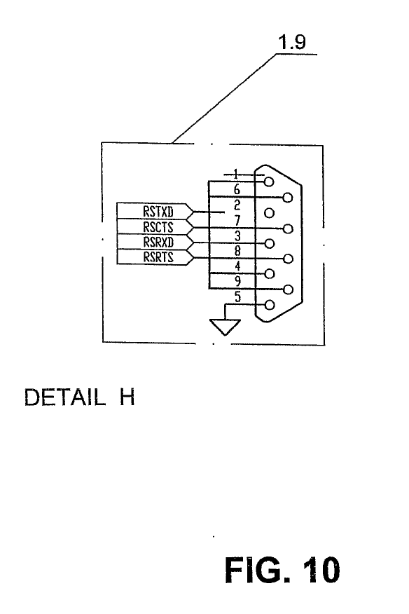

FIG. 10 shows for the patent of invention “Remote Multipoint Monitoring and Timeline Analysis Equipment”, detail H of the electric wiring diagram for the control unit (UC), FIG. 2.

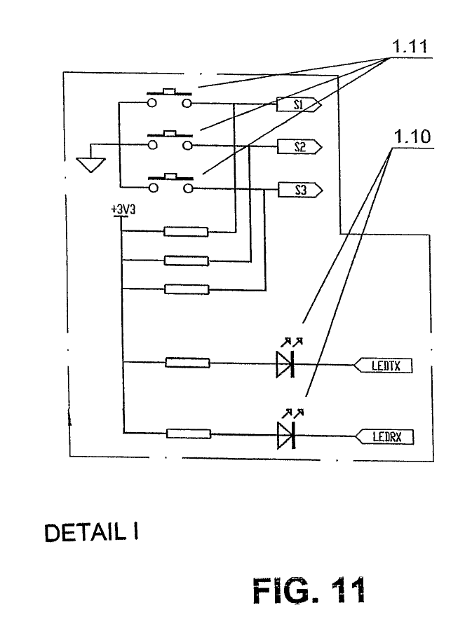

FIG. 11 shows for the patent of invention “Remote Multipoint Monitoring and Timeline Analysis Equipment”, detail I of the electric wiring diagram for the control unit (UC), FIG. 2.

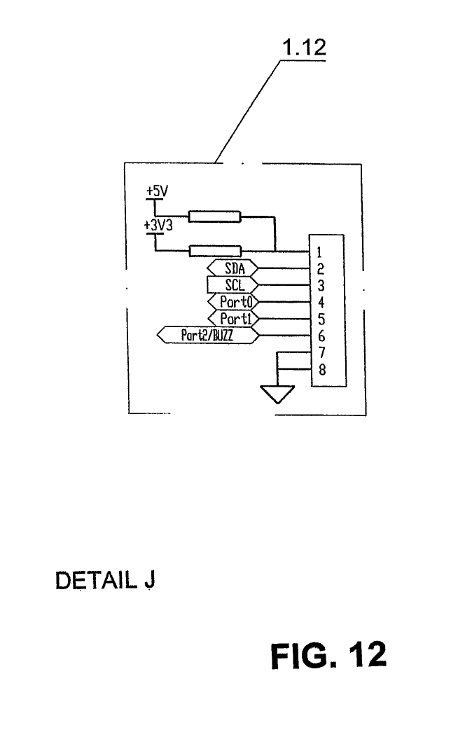

FIG. 12 shows for the patent of invention “Remote Multipoint Monitoring and Timeline Analysis Equipment”, detail J of the electric wiring diagram for the control unit (UC), FIG. 2.

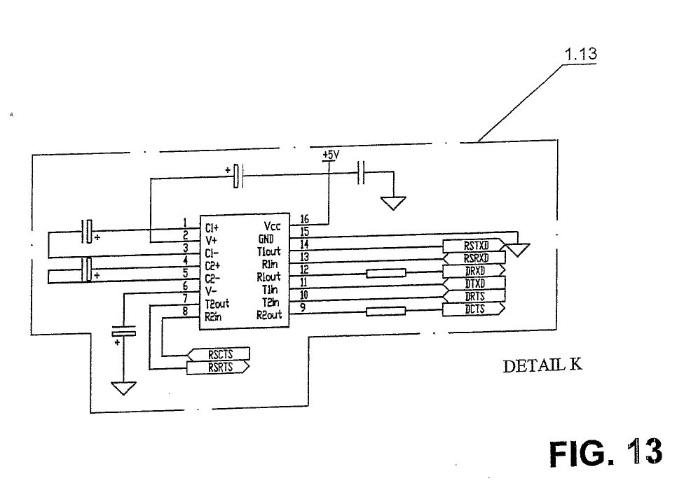

FIG. 13 shows for the patent of invention “Remote Multipoint Monitoring and Timeline Analysis Equipment”, detail K of the electric wiring diagram for the control unit (UC), FIG. 2.

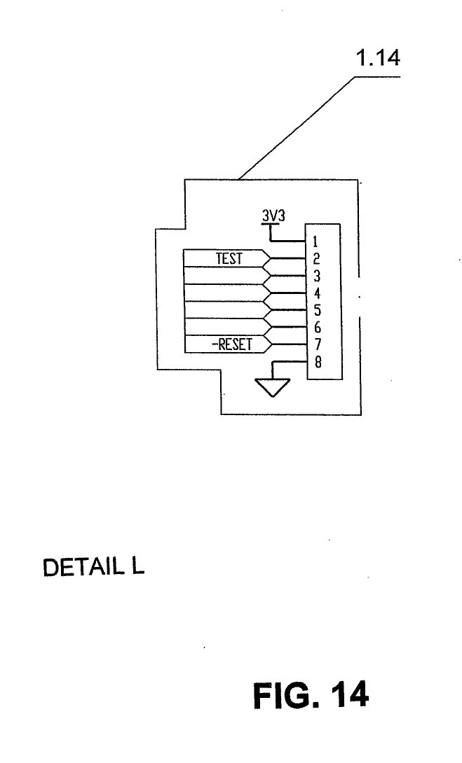

FIG. 14 shows for the patent of invention “Remote Multipoint Monitoring and Timeline Analysis Equipment”, detail L of the electric wiring diagram for the control unit (UC), FIG. 2.

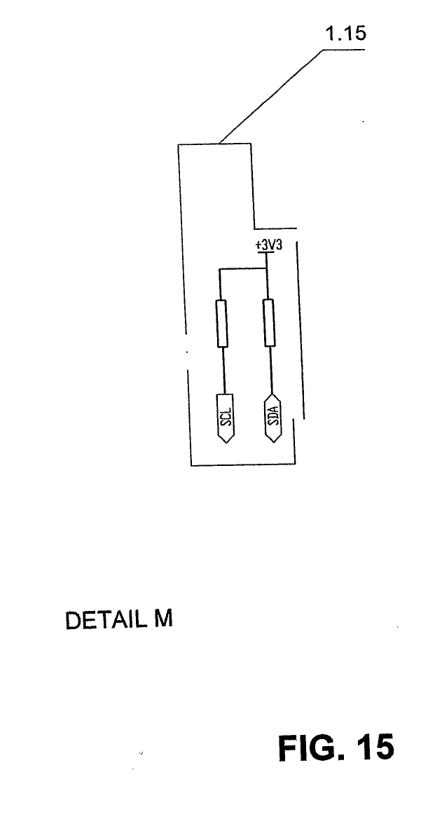

FIG. 15 shows for the patent of invention “Remote Multipoint Monitoring and Timeline Analysis Equipment”, detail M of the electric wiring diagram for the control unit (UC), FIG. 2.

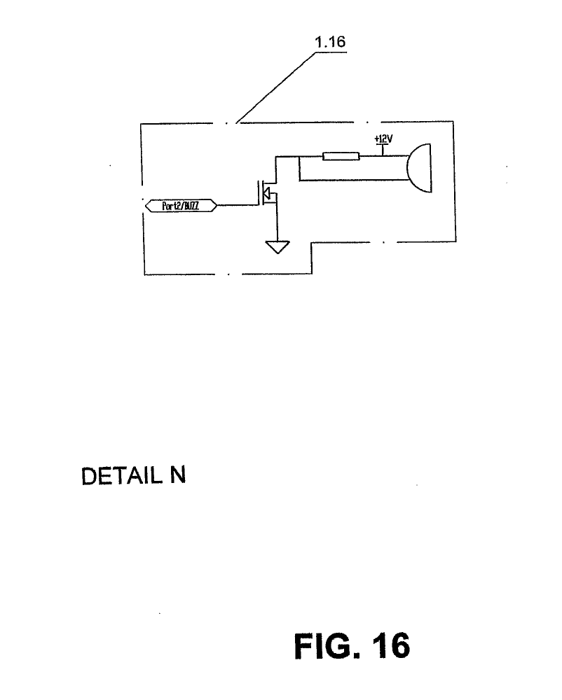

FIG. 16 shows for the patent of invention “Remote Multipoint Monitoring and Timeline Analysis Equipment”, detail N of the electric wiring diagram for the control unit (UC), FIG. 2.

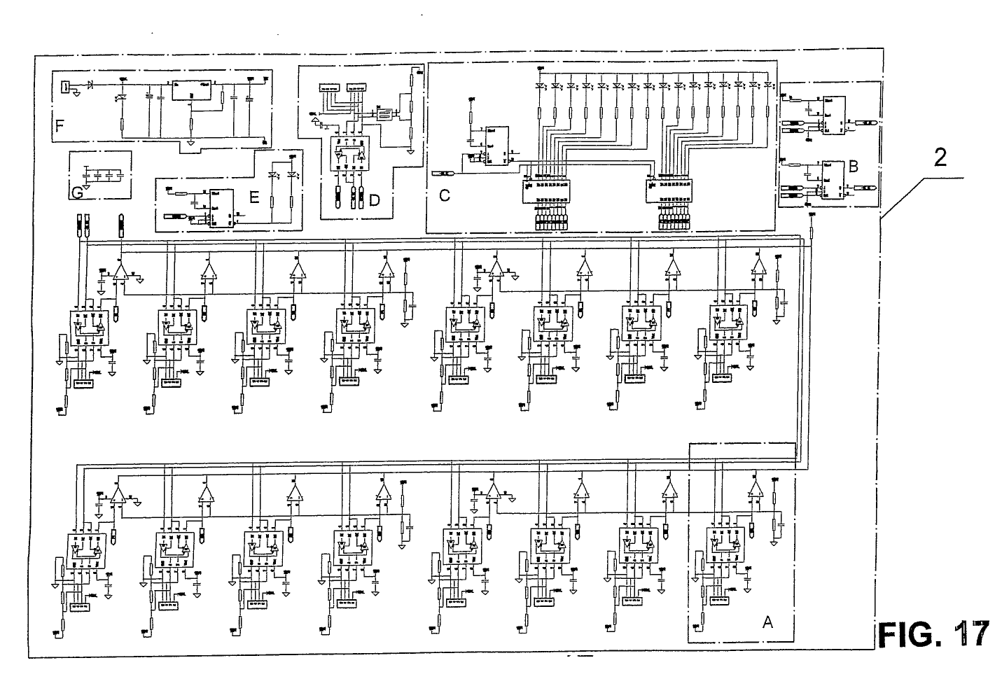

FIG. 17 shows of the patent of invention for “Remote Multipoint Monitoring and Timeline Analysis Equipment”, the electric wiring diagram for the board of the retransmission unit (HUB).

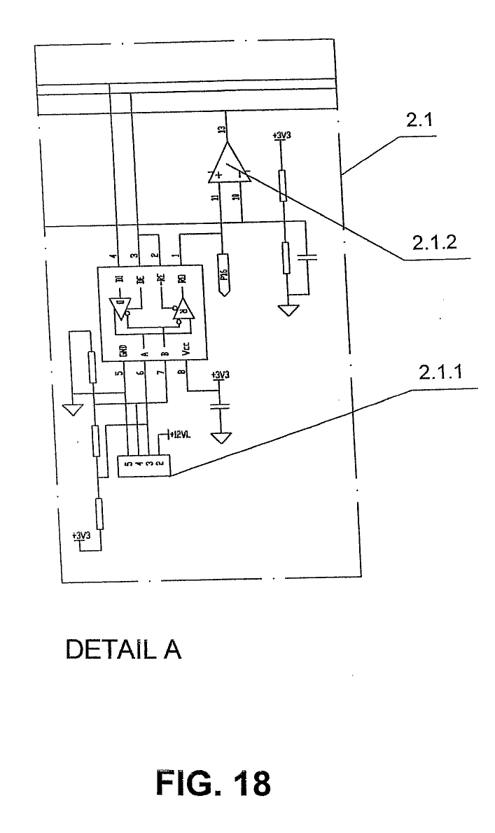

FIG. 18 shows of the patent of invention for “Remote Multipoint Monitoring and Timeline Analysis Equipment”, detail A of the electric wiring diagram for the board of the retransmission unit (HUB), FIG. 17.

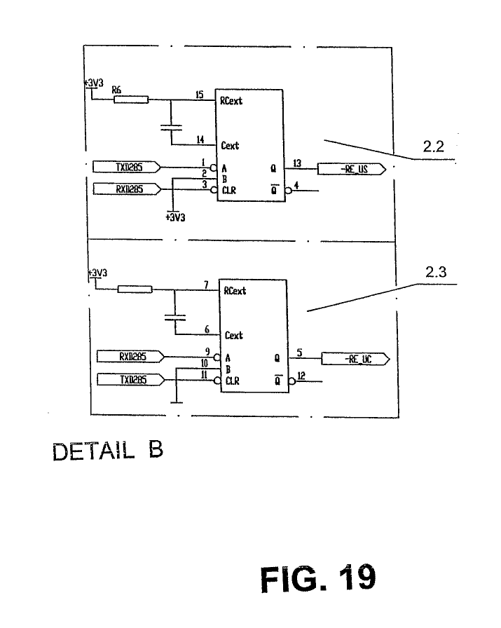

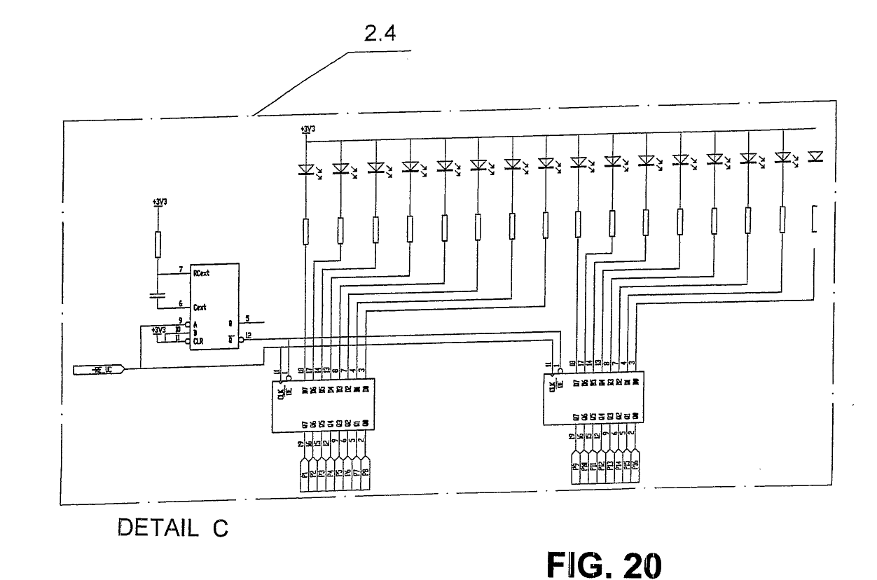

FIG. 19 shows of the patent of invention for “Remote Multipoint Monitoring and Timeline Analysis Equipment”, detail B of the electric wiring diagram for the board of the retransmission unit (HUB), FIG. 17.

FIG. 20 shows of the patent of invention for “Remote Multipoint Monitoring and Timeline Analysis Equipment”, detail C of the electric wiring diagram for the board of the retransmission unit (HUB), FIG. 17.

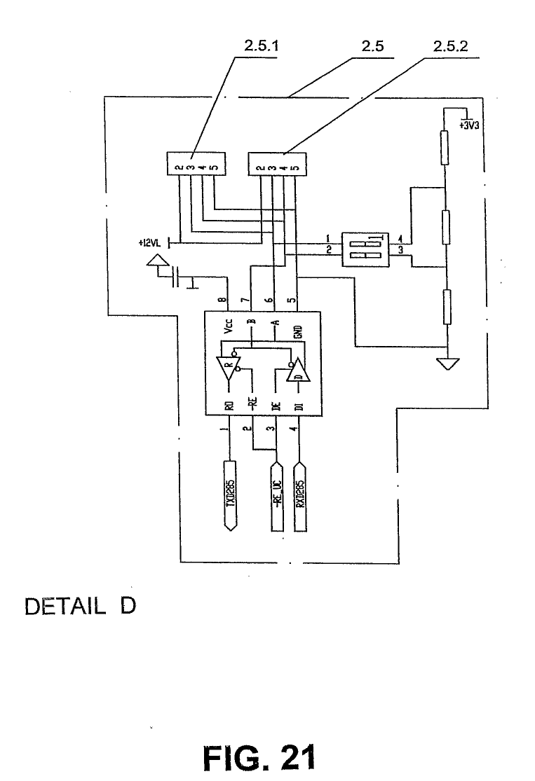

FIG. 21 shows of the patent of invention for “Remote Multipoint Monitoring and Timeline Analysis Equipment”, detail D of the electric wiring diagram for the board of the retransmission unit (HUB), FIG. 17.

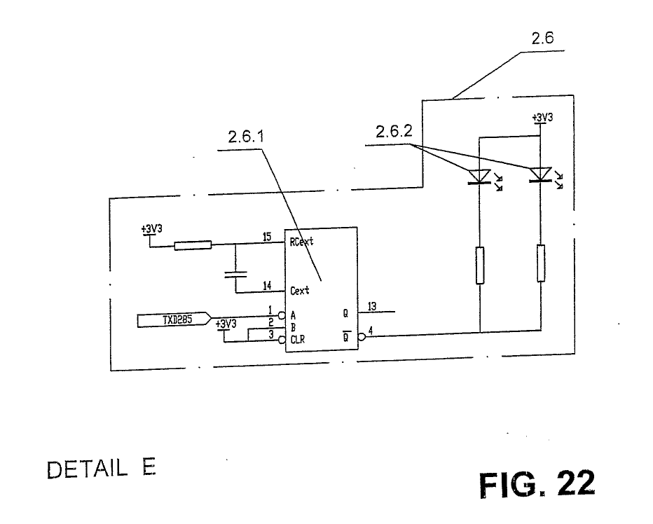

FIG. 22 shows of the patent of invention for “Remote Multipoint Monitoring and Timeline Analysis Equipment”, detail E of the electric wiring diagram for the board of the retransmission unit (HUB), FIG. 17.

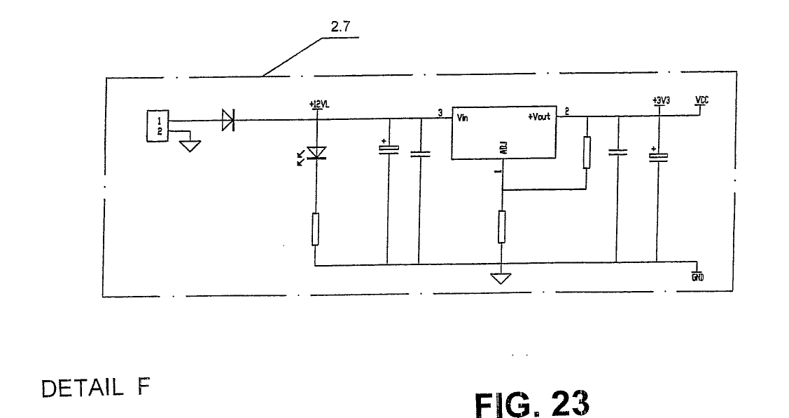

FIG. 23 shows of the patent of invention for “Remote Multipoint Monitoring and Timeline Analysis Equipment”, detail F of the electric wiring diagram for the board of the retransmission unit (HUB), FIG. 17.

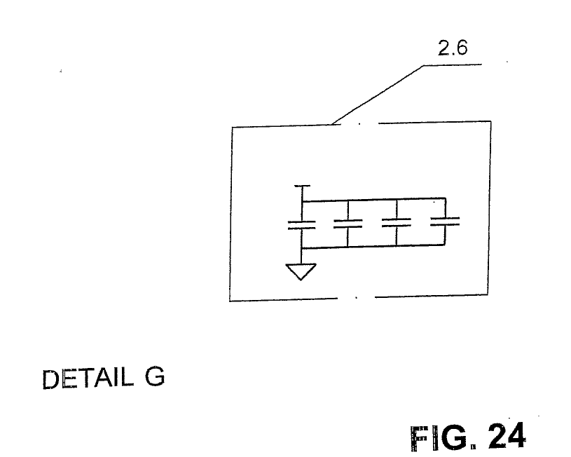

FIG. 24 shows of the patent of invention for “Remote Multipoint Monitoring and Timeline Analysis Equipment”, detail G of the electric wiring diagram for the board of the retransmission unit (HUB), FIG. 17.

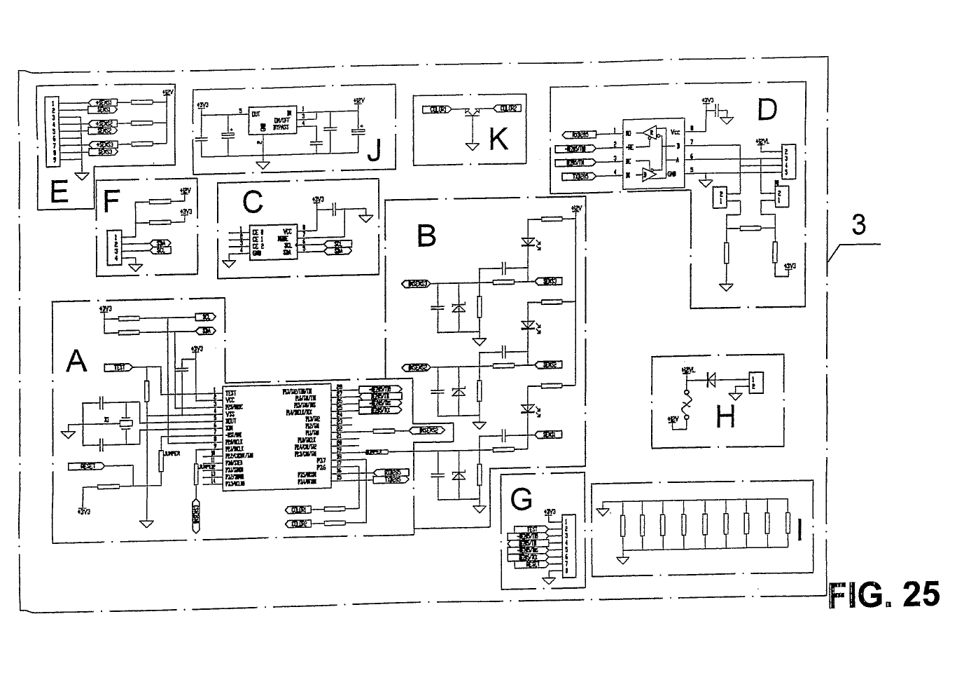

FIG. 25 shows of the patent of invention for “Remote Multipoint Monitoring and Timeline Analysis Equipment”, the electric wiring diagram for the board of the sensor unit (US), FIG. 25.

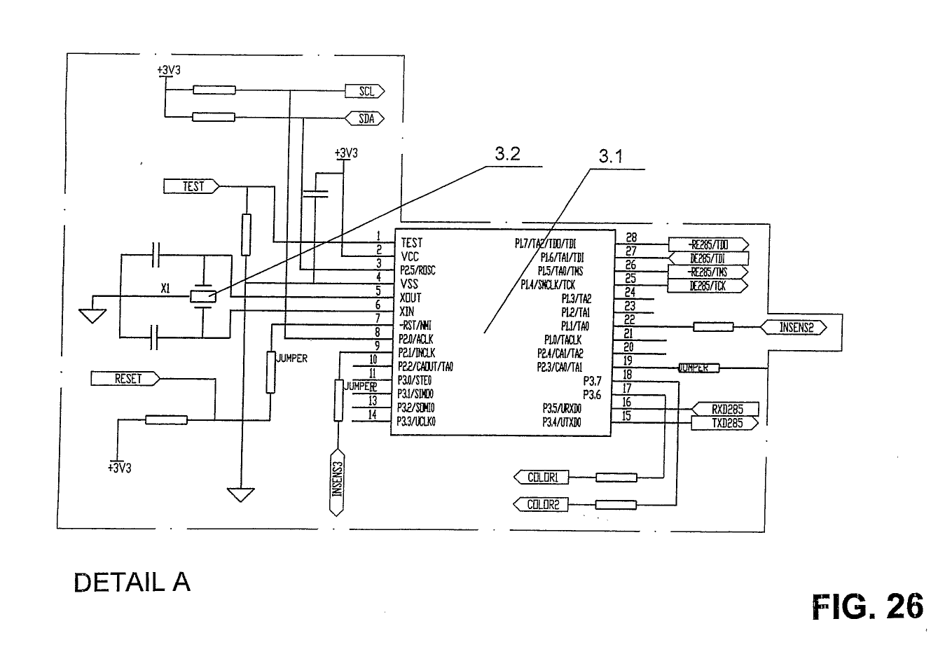

FIG. 26 shows of the patent of invention for “Remote Multipoint Monitoring and Timeline Analysis Equipment”, detail A of the electric wiring diagram for the board of the sensor unit (US), FIG. 25.

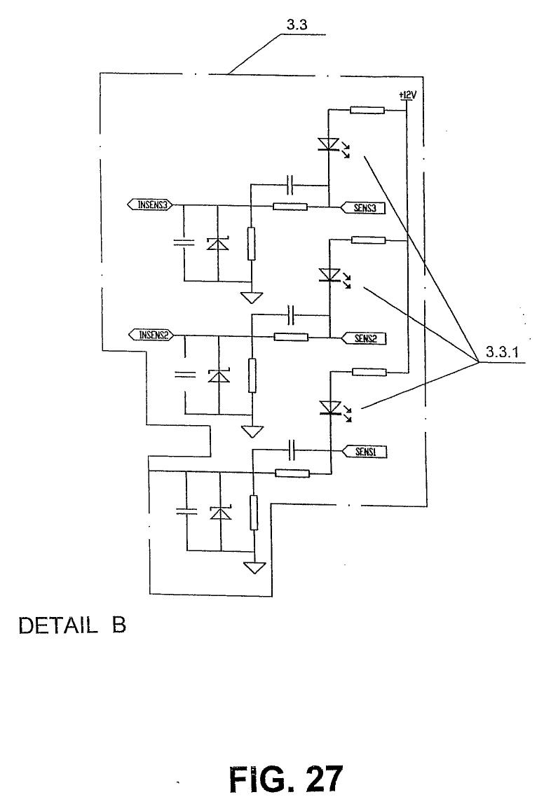

FIG. 27 shows of the patent of invention for “Remote Multipoint Monitoring and Timeline Analysis Equipment”, detail B of the electric wiring diagram for the board of the sensor unit (US), FIG. 25.

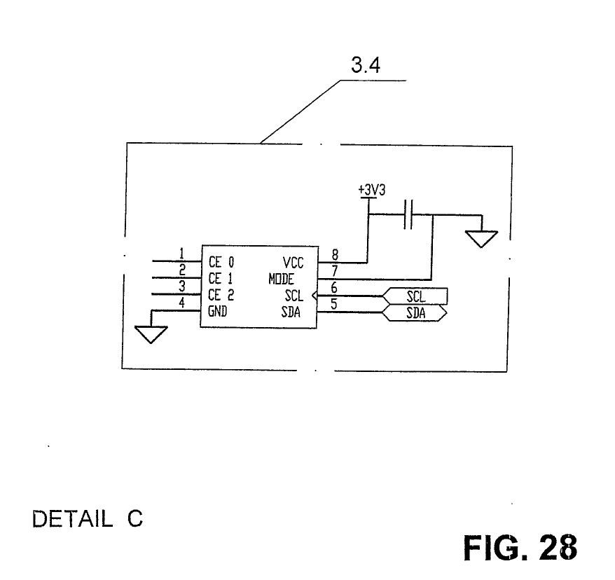

FIG. 28 shows of the patent of invention for “Remote Multipoint Monitoring and Timeline Analysis Equipment”, detail C of the electric wiring diagram for the board of the sensor unit (US), FIG. 25.

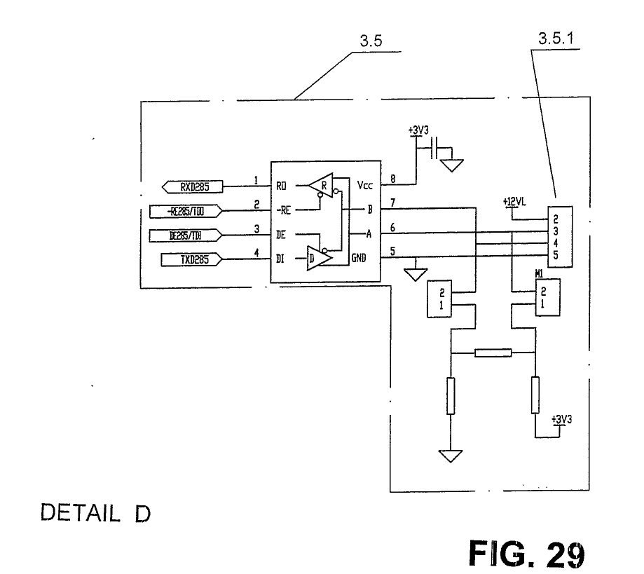

FIG. 29 shows of the patent of invention for “Remote Multipoint Monitoring and Timeline Analysis Equipment”, detail D of the electric wiring diagram for the board of the sensor unit (US), FIG. 25.

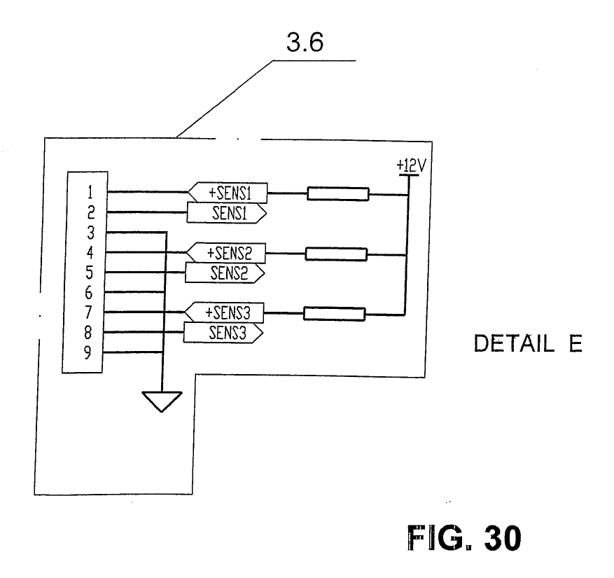

FIG. 30 shows of the patent of invention for “Remote Multipoint Monitoring and Timeline Analysis Equipment”, detail E of the electric wiring diagram for the board of the sensor unit (US), FIG. 25.

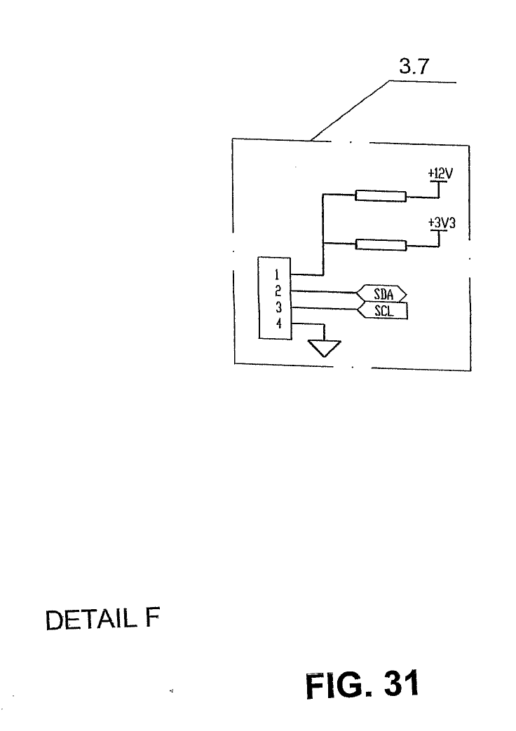

FIG. 31 shows of the patent of invention for “Remote Multipoint Monitoring and Timeline Analysis Equipment”, detail F of the electric wiring diagram for the board of the sensor unit (US), FIG. 25.

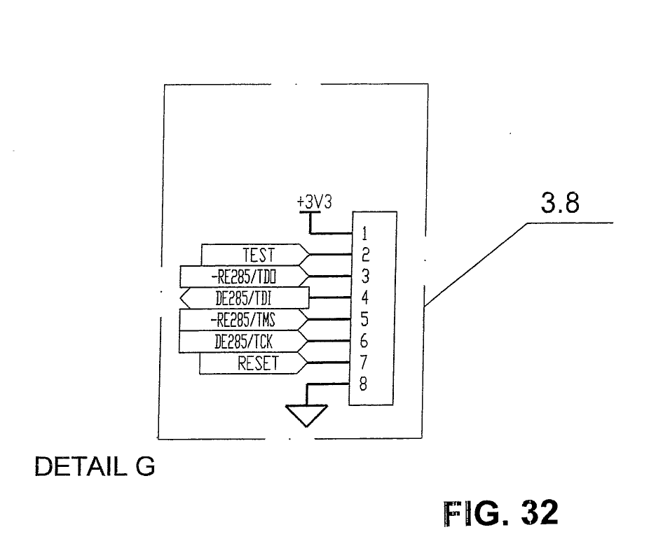

FIG. 32 shows of the patent of invention for “Remote Multipoint Monitoring and Timeline Analysis Equipment”, detail G of the electric wiring diagram for the board of the sensor unit (US), FIG. 25.

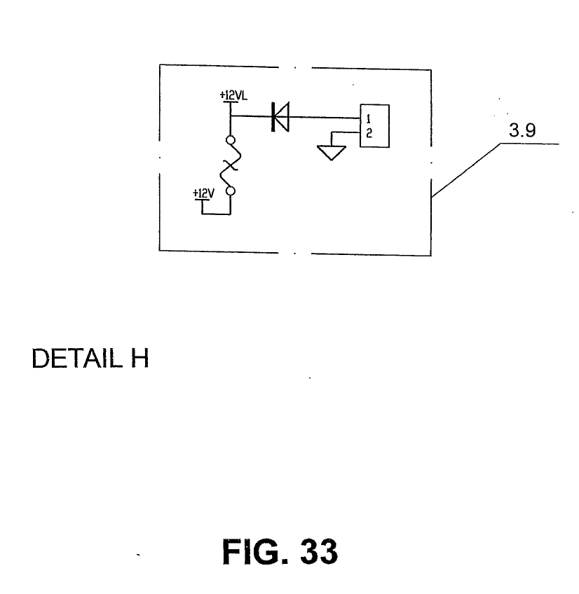

FIG. 33 shows of the patent of invention for “Remote Multipoint Monitoring and Timeline Analysis Equipment”, detail H of the electric wiring diagram for the board of the sensor unit (US), FIG. 25.

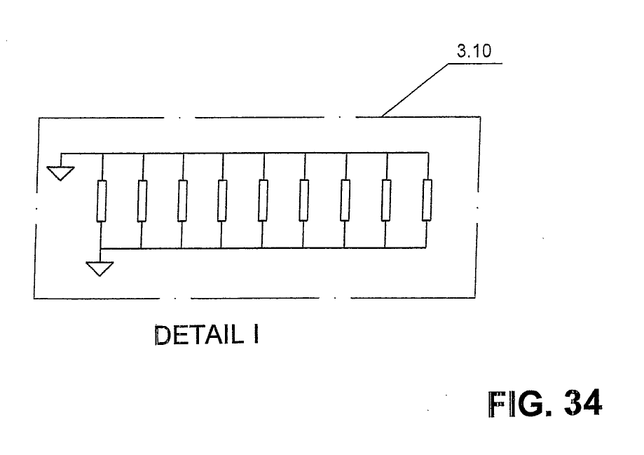

FIG. 34 shows of the patent of invention for “Remote Multipoint Monitoring and Timeline Analysis Equipment”, detail I of the electric wiring diagram for the board of the sensor unit (US), FIG. 25.

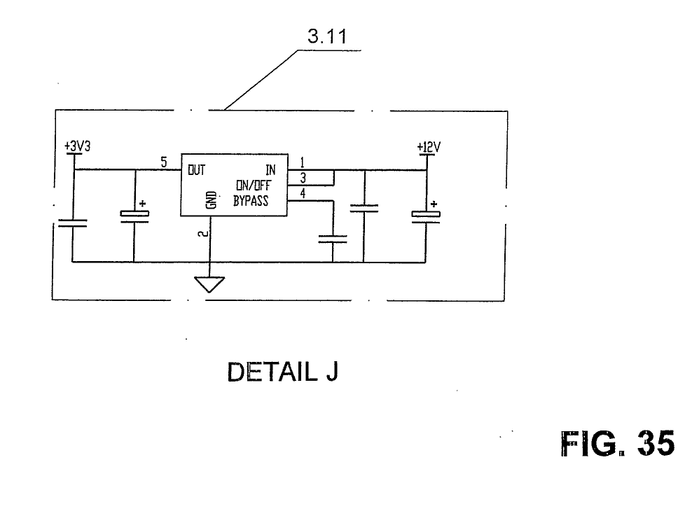

FIG. 35 shows of the patent of invention for “Remote Multipoint Monitoring and Timeline Analysis Equipment”, detail J of the electric wiring diagram for the board of the sensor unit (US), FIG. 25.

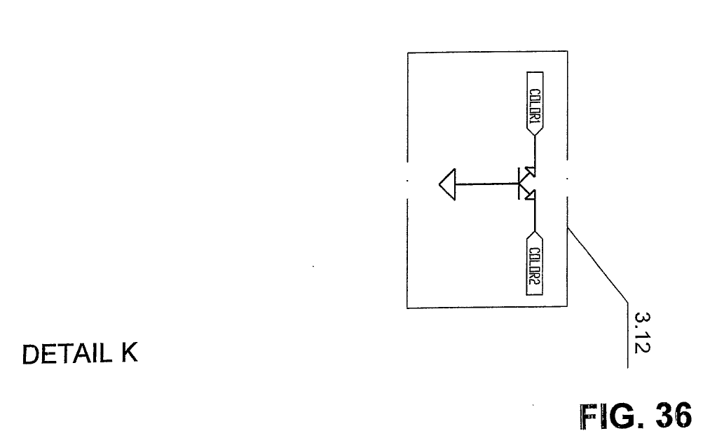

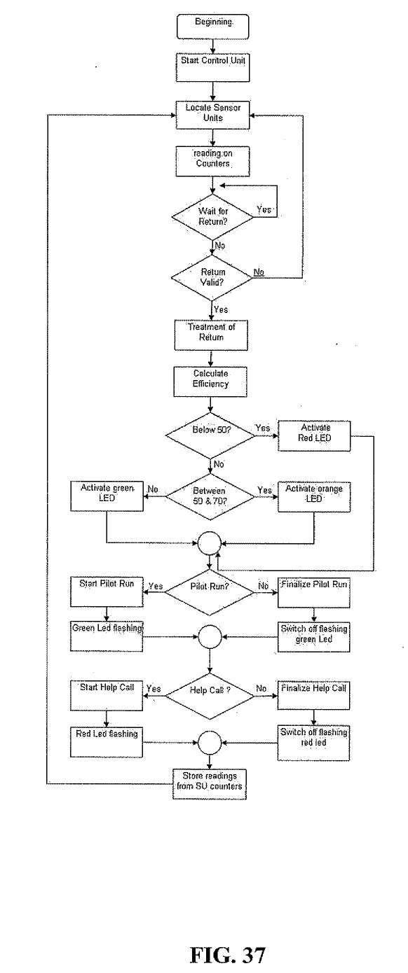

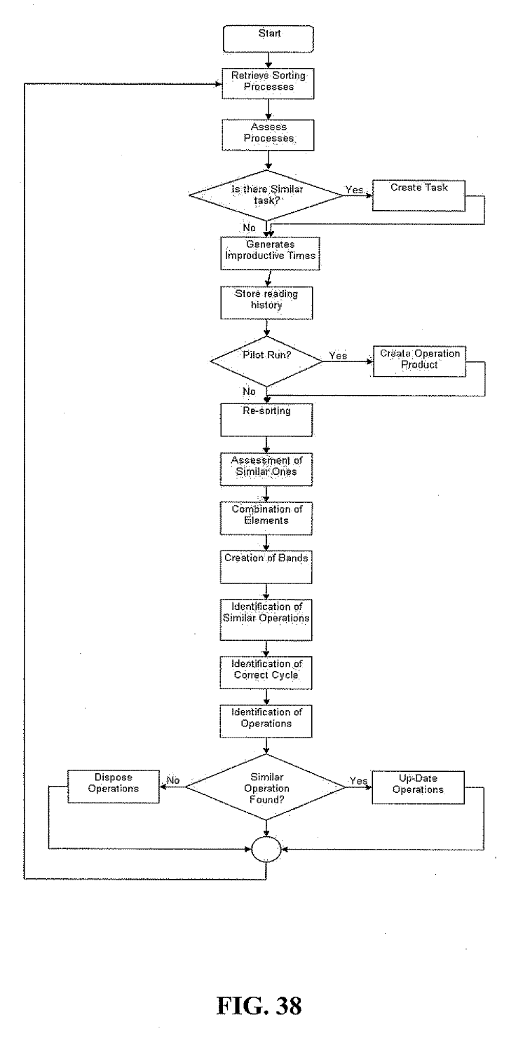

FIG. 36 shows of the patent of invention for “Remote Multipoint Monitoring and Timeline Analysis Equipment”, detail K of the electric wiring diagram for the board of the sensor unit (US), FIG. 25.

As shown in FIGS. 01 to 36, this patent of invention called “Remote Multipoint Monitoring and Timeline Analysis Equipment”, features a basic functional make up comprised of 04 basic items (1), (2), (3) and (4). These basic items are characterized by the following characteristics: control unit (UC) (1), retransmission unit (HUB) (2), sensor unit (US) (3) and sensors (4).

Henceforth, the control unit (1) will be called UC (1), the retransmission unit (2), HUB (2) and the sensor unit, US (3).

The patent of invention for “Remote Multipoint Monitoring and Timeline Analysis Equipment” is formed by a data communication network comprised of, basically, three different modules: UC (1), HUB (2) and US (3).

UC (1) is an electronic, microprocessor controlled module, FIGS. 2 and 3, and has two communication ports, FIGS. 2, 6, 10 and 13, whose function is to connect sequentially, based on commands sent by a PC, FIG. 1, to USs (3), FIG. 25, and through sub-command protocols collect from these USs (3), data in general terms.

HUB(2), FIGS. 1 and 17, is an electronic module whose function is arbitrating the medium of communication, allowing UC (1) to link up and connect to any USs (3). Basically, HUB (2) has two RS-485 type ports for the primary network, FIG. 21, connectors (2.5.1) and (2.5.2). One RS-485 port connects to UC (1), FIG. 6, type RJ45PCI connector (1.4.1). The other port can be used for network increase purposes by connecting this point to another HUB (2).

In the patent of invention for “Remote Multipoint Monitoring and Timeline Analysis Equipment” each HUB has sixteen RS-485 serial interface drivers, shown in FIGS. 17 and 18. Cables coming from the USs (3) that form the secondary network are linked to connectors (2.1.1).

US (3), FIGS. 1 and 25, is an electronic, microprocessor controlled, addressable module, whose function is to carry out monitoring and control programs and report data to UC (1), based on the sub-commands sent by the latter.

The network structure is of the “half-duplex” type, that is, there is only one communication direction and only one device transmitting at a time, with all the communication being initiated from UC (1). All communication is initiated by UC (1). After receiving and re-transmitting through every port a command received from UC (1), HUB (2) goes into a waiting state for a return from the specific US (3) to which the command was issued. Therefore, only one US (3) responds at a time to the command, for this reason there is no congested traffic in the single channel.

All the interconnections are performed via RS-485 interface, with RJ-11 connectors, except for the connection between the PC (5) and the UC (1), which is type RS-232.

The PC (5) is connected to the UC (1) through an RS-232 port, FIGS. 2, 10 and 12, at a fixed baud rate of 115.2 kbps; and through the RS-485 port, FIGS. 2 and 6, to a HUB (2), also at a fixed baud rate of 115.2 kbps, forming the primary network.

FIG. 1 brings the overall schematic diagram of the patent of invention for the “Remote Multipoint Monitoring and Timeline Analysis Equipment”. The diagram shows this to be a data transmission and management network that delivers, through indication LEDs and a PC (5) loaded with the appropriate “user interface” type software, the necessary information for corrections and better operator suitability associated to the machines.

The UC (1) of the patent of invention for “Remote Multipoint Monitoring and Timeline Analysis Equipment” is comprised of a printed circuit board, on which the following components are assembled, as shown in FIGS. 2 to 16: the circuit for the card for the control unit (1)—FIG. 2, micro-processor controller (1.1)—FIG. 3, crystal oscillator (1.1.1), crystal oscillator (1.1.2), 32 kbytes RAM memory (1.2), with 5-volt power input—FIG. 4, E2PROM memory (1.3) with 3.3-volt power input (1.2.1)—FIG. 5, RS485 serial interface driver (1.4), with its RJ45PCI connector (1.4.1) and re-setting circuit breaker (1.4.2)—FIG. 6, 5-volt (1.5) and 3.3-volt (1.6) voltage regulators—FIG. 7, connector for display and liquid crystal LDC (1.7)—FIG. 8, real time clock RTC (1.8), with its battery (1.8.1)—FIG. 9, RS232 (1.9) interface—FIG. 10, communication interface LEDs (1.10) and tact-switches (1.11)—FIG. 11, expansion connector (1.12)—FIG. 12, RS-232 serial interface driver (1.13)—FIG. 13, JTAG interface connector (1.14)—FIG. 14, 3.3-volt power input (1.15)—FIG. 15, and sound alarm (1.16)—FIG. 16.

In the patent of invention for “Remote Multipoint Monitoring and Timeline Analysis Equipment”, the micro-processed controller (1.1), FIG. 3, of the UC (1), receives its programming through connector (1.14), and communicates with the PC through the RS-232 serial driver (1.13) and with the HUB (2) through the RS-485 serial driver (1.4) and its RJ45PCI connector (1.4.1).

In case of failure of the micro-processed controller (1.1) or recognizes a failure, the sound alarm (1.16)—FIG. 16 will sound out.

The E2PROM memory (1.3), FIG. 5, where the address codes are stored, is used exclusively by the micro-processed controller (1.1).

The crystal oscillators (1.1.1) mark the frequency of the work.

The board uses a 12-volt power input and, therefore, in order to operate the different components installed on the UC (1), the voltage regulators for 5 Volts (1.5) and 3.3 Volts (1.6)—FIG. 7, were placed on the board.

There is an option for connection to a liquid crystal LDC display at the terminal (1.7)—FIG. 8.

The real time clock—RTC (1.8), with its battery (1.8.1)—FIG. 9, as stated in the name, supplies real time data, used in identifying events in the time continuum and for calculation of efficiencies.

The communication interface LEDs (1.10) supply visual information about the communication traffic.

There is an option for tact-switches (1.11)—FIG. 11 for powering external commands, such as for example, the function switches for as possible LCD.

In the patent of invention for “Remote Multipoint Monitoring and Timeline Analysis Equipment”, the micro-processed controller's (1.1) program is loaded through the JTAG interface connector (1.14)—FIG. 14, with a 3.3-volt power source requirement.

The micro-processed controller for the 32 kbytes static RAM (1.2) is foreseen for an eventual expansion in the memory for data.

The retransmission unit (2), called HUB, of the patent of invention for “Remote Multipoint Monitoring and Timeline Analysis Equipment” is comprised of a printed circuit board, where, as shown in FIGS. 17 to 24, the following components are assembled: circuit for the card of the retransmission unit (2)—FIG. 17, RS-485 serial driver (2.1), with its connector (2.1.1) and its voltage comparison device (2.1.2)—FIG. 18, controller for direction of communication UC to US (2.2) and controller for direction of communication US to UC (2.3)—FIG. 19, circuit for US communication indication LEDs (2.4)—FIG. 20, RS-485 serial driver (2.5), with its connectors (2.5.1) and (2.5.2)—FIG. 21, single stable circuit (2.6) with single stable (2.6.1) and UC to US communication indication LEDs (2.6.2)—FIG. 22, 3.3 volt voltage regulator (2.7)—FIG. 23, integrated circuit uncoupling capacitors (2.8)—FIG. 24.

In the patent of invention for “Remote Multipoint Monitoring and Timeline Analysis Equipment”, the RS-485 serial interface driver (2.1) FIGS. 17 and 18, with its connector (2.1.1) allows communication between the HUB (2) and its USs (3).

All communication is initiated by the UC (1). After receiving and re-transmitting through every port a command coming from the UC (1), HUB (2) enters a stand by state for a return from the specific US (3) to which the command was issued. Therefore, only one US (3) at a time responds to the command, for this reason there is congested traffic in the single channel.

The voltage comparison device (2.1.2)—FIG. 18 is linked to the single channel for response from the US (3) specified.

The circuit for the US communication indication LEDs (2.4)—FIG. 20 visually indicates the port on the US (3) that is communicating at that moment.

In the patent of invention for the uRemote Multipoint Monitoring and Timeline Analysis Equipment”, the RS-485 serial interface driver (2.5), with its connectors (2.5.1) and (2.5.2)—FIG. 22 allows connection with the UC (1) and the other, to HUB (2) for expansion of the secondary network.

The single stable circuit (2.6) with the single stable (2.6.1) and UC (1) to US (2.6.2) communication indication LEDs, performs the function of arbitrating communicating paths arbitrating their direction. The 3.3 volt voltage regulator (2.7)—FIG. 23 transforms the board's power input, from 12 volts, to 3.3 volts, value used in the circuits of the HUB (2).

Integrated circuit uncoupling capacitors (2.8)—FIG. 23 are close to their own power input pins.

The US (3) used in the patent of invention for “Remote Multipoint Monitoring and Timeline Analysis Equipment” is comprised of a printed circuit board where the following components are assembled as shown in FIGS. 25 to 36: sensor unit circuit board (25), micro-processor controller (3.1) with crystal oscillator (3.2)—FIG. 26, signal adapters (3.3.) with communication indication LEDs (3.3.1)—FIG. 27, E2PROM memory (3.4) with 3.3 volt power input—FIG. 28, RS-485 serial interface driver (3.5), with its RJ45PCI connector (3.5.1)—FIG. 29, connector for sensors (3.6)—FIG. 30, connector for expansion of the hardware—FIG. 31, load connector (3.8)—FIG. 32, additional source connector (3.9) with reset circuit breaker (3.9.1)—FIG. 33, jumpers (3.10)—FIG. 34, 3.3-volt voltage regulator (3.11)—FIG. 35, two-color LED (3.12)—FIG. 36.

In the US (3) of the patent of invention for “Remote Multipoint Monitoring and Timeline Analysis Equipment” the micro-processed controller (1) receives its program through connector (3.8)—FIG. 32 and has its work frequency defined by the crystal oscillator (3.2).

The E2PROM memory (3.4) FIG. 28 stores the sensor address codes (4).

The connector (3.7)—FIG. 31 is an interface type I2C for an eventual board with additional hardware or hardware expansion.

The jumpers (3.10)—FIG. 34 represent the inter-connections between the tracks or also called stopovers.

Sensors (4)—FIG. 1 are of the Hall effect type and are connected to the US (3) through the connector (3.6). FIG. 27 shows a signal adapter circuit (3.3) that acts a “line noise” filter, delivering a cleaner signal to the US (3). The LED(3.3.1)—FIG. 27 gives an indication of the communication with the sensor.

The US (3) communicates with its HUB (2) via the RS-485 serial interface driver (3.5)—FIG. 29, through its RJ45PCI connector (3.5.1)—FIG. 30.

The additional power source connector (3.9) with reset circuit breaker (3.9.1)—FIG. 33 are foreseen in the event an additional source is used in future.

Jumpers (3.10)—FIG. 34 are interconnections between tracks, and the 3.3 volt voltage regulator (3.11)—FIG. 35 serves to provide the appropriate voltage to the E2PROM memory (3.4) and the micro-processed controller (3.1)

The two-color LED (3.12)—FIG. 36 indicates the board's operational status. When ON, it indicates severe hardware error.

In order to operate, the patent of invention for “Remote Multipoint Monitoring and Timeline Analysis Equipment” deploys three program modules: the reading module, the process separation and production control module and the user interface module.

The reading modulo was developed to interact with hardware. It performs the reading of the sensor units (3) and generates data from the time takings, according to the alterations of sensor states.

The Process Separation and Production Control Module is the more complex of the modules, because of working with high flow data stream and being in charge of managing all the information, it transforms the data collected into information, by separating processes and analysis of the production line. This is where the equipment's real functionality is delivered. This module manages the work of the equipment on the production line and is in charge of locating and identifying the sensor units US (3) operating normally and/or with problems.

The module separates out the processes, by analyzing the data obtained by the USs (3), and uses them in efficiency calculations whose results are displayed by the user interface software.

The User Interface Module is the interface with users, through which all the manipulation (registers) and visualization of the information generated through the readings made and treated in the sorting processes.

For the proper operation of the patent of invention for “Remote Multipoint Monitoring and Timeline Analysis Equipment”, it is necessary to create a register for all the types of machines, machines, cells, staff and parts sets.

The equipment, through its software, allows automatic product technical sheet records to be created, through readings of the processes carried out on the machines; i.e., the sequence of operations performed by the machine is standardized.

Through the product technical data sheet, it is possible to balance the production line for that specific product, identifying the best form of production.

Using the standard time found on the technical data sheets, the reading and separation modules calculate operator efficiency, displaying this graphically through line chart measuring devices.

The management software is capable of recognizing each US unit connected to this network, and the latter take readings or receive instructions from the ports. Several types of sensors and contactors can be connected to these ports. On garment production lines, a choice was made for hall type sensors for reading number of stitches and number of activations of the press foot. Information captured by the readings are received by the USs (3), forwarded by the HUB (2) that is passed on to the UC (1). The reading program reads the UC (1), organizes this information and compares this with the readings already stored on the database. Deploying artificial intelligence logic, the patent of invention for “REMOTE MULTIPOINT MONITORING AND TIMELINE ANALYSIS EQUIPAMENT” identifies similar processes, whether productive or not, and carries out all the calculations for the timeline analysis of efficiencies and stores these on an SQL database. Running these on the server PC, the information management, User Interface software identifies everything that is being produced on the production line detailed per machine that, in its turn, is being operated by an operator with a set shift time.

Results achieved with the information:

Productivity report detailed per operator, cells or the plant. Parts produced; Longer or shorter time per operation; Productive times; Improductive times; Comparison among processes, among operators (studies of times and movements).

Statistics-based forecasts; Product delivery dates; Programmed purchase of manufacture items; Indication of most efficient lines (people with the same efficiencies); Forecast of production line bottlenecks (real time); Plant increase; Production balance (distribution of work and positions).

The patent of invention for “REMOTE MULTIPOINT MONITORING AND TIMELINE ANALYSIS EQUIPAMENT” does not have the objective of automating machines, but rather automating production monitoring, on any type of machine or worker. Through artificial intelligence learn from the information supplied by each worker and machine and, based on this information set, suggest possible process improvements and production line balancing leading to higher optimization of the lines.

In based this patent have a method for remote multipoint monitoring and timeline analysis brings a definition of the algorithm specifies each action in the process or method. The enhancement developed and added to the patent consists in the innovations introduced in it through the algorithms deployed in the method for remote multipoint monitoring and timeline analysis.

As advised in the report for PI0404926-8, once defined the steps to be followed, the following are made available: detailed productivity per operator, cell or plant report, including number of parts produced; longest and shortest time per operation, productive times, non productive times, comparison of operations carried out by operadores (times and movement studies); statistical forecast for product delivery date, scheduled purchases for make up items, indication of most efficient lines (people with the same efficiency, real time line bottleneck forecasts, plant capacity increase, balancing of production (distribution of work and lay out).

For the purpose of clarification of this descriptive report for the Certificate of Addendum to Patent of Invention, we supply below a few definitions and sequences of steps for developing a patent such as the one for method for remote multipoint monitoring and timeline analysis:

In developing this type of method, which makes use of purpose specific equipment, first the physical medium, platform or hardware must be defined, based on a sequence of basic steps, i.e., the basic preliminary algorithm, as well as for the expected results, for instance, the desired actions, screens and reports.

The definitive algorithm is then created, which is the exact sequence of steps to be followed according to each of a range of different situations or states possibly encountered in the manufacture process and in the method for remote monitoring and timeline analysis. This is the method used to attain the desired end product.

The computer program, in English the “software”, is the translation of the algorithm for the execution method, into computer programming lines in one of the many existing machine programming languages.

The equipment itself, because of being electronic printed circuits, commonly known by the English term “hardware”, has been fully defined and presented in the original patent PI0404926-8.

As shown in FIGS. 1 to 36 of PI0404926-8, initially called “EQUIPMENT FOR REMOTE MULTIPOINT MONITORING AND TIMELINE ANALYSIS”, is characterized by featuring one control unit (UC) (1), retransmission unit (HUB) (2), sensor unit (US) (3), sensors (4) and PC (5).

According to PI0404926-8, the algorithm found in this addendum certificate's claim is the logic that allows the signals coming from the sensors (4), to be presented in reports and displayed on screens of the PC, as well as allowing the interaction of the user with the multipoint monitoring and timeline analysis method.

This algorithm follows the following instructions:
a) For arithmetic operation signs: “+” means addition; “−” means subtraction; “/” means division; “*” means multiplication; “ˆ” means exponent; “Mod” the remainder of a division.
b) For Comparison Signs: “=” means equal; “>” more than; “<” means less than; “< >” means different; “>=” means more than or equal to; “<=” means less than or equal to; “No” means similar to different, used in logic expressions to invert a Boolean value.
c) For Boolean Values (logic): “True” means true; “False” means false; “Not True” means not true or false; “Not False” means not false or true.
d) For Language Structure: “Unit” means program unit; “Procedure” or “arguments” means procedure for execution, arguments means parameters passed, procedures do not have returns; “function”, “arguments”, “Return Type” means procedure with specified return type; “variables” means stating variables; “Beginning” means beginning of the command block; “End” means end of a command block; “End unit” means end of the program unit.
e) For Repetition loops: “As long as <Logic expr.> Do” means repeat the loop as long as the logic expression is true; “For<var>:=<start value> until <final value> Do” means repeat the loop until <var> reached the end value; “Continue” means return to the beginning of the loop; “Stop” means go to end of loop.
f) For Data Types: “Integer” means whole number, initial value 0 (zero); “Real” means decimal number, initial value 0 (zero); “Text” means set of characters, initial value ‘ ’, “Matrix [ ]” means value matrix; “Hex” means hexadecimal, initial value Oh; “DateTime” means date and time field.
g) For Conditional Structures: “if <logic exp.> Then if not” means conditional structure for execution of tasks.
h) For others: “:=” means attribution of value; “;” means command finalizer; “implementation” means beginning of implementation of the structure; “Pos(strSearch,str)” means position of “strSearch” in “str”; “copy(str, beginning, end)” means return the part between beginning and end; “Length(str)” means return the length/size of “str”; “TextToHex” means conversion of text into hexadecimal; “HexToText” means conversion of hexadecimal into text; “Val(text)” means conversion of text value into numeric format; “In_Seconds(date1, date2)” means difference in seconds between “date1” and “date2”; “procedureStoreRecord(US, dateTimeBeginning, dateTimeEnd, statusSensor, portsensor, points, presser foot, identifyTask, beginSeparation)” means store element in database; “Now” means return of current date and time; “HexToInteger” means conversion of hexadecimal value into whole number; “searchShifts(list, index)” means return work shift list, with 1st element being the date, 2nd element is the time of beginning and the 3rd element is the end time; “minutesToHours” means return the value in hours; “searchHistory(sensor, beginningprocess, EndProcess, points, time, timeStandard, processes, processesError, timeMachine)” means query the database for the values of the sensor for the period informed, accumulate point data, time, standard time, processes, processes with errors and machine time; “Select_Readings(US, elementEnd, processPoints, processPresserFoot, processBeginning, processEnd, processTime, timeMachine)” means query for readings, accumulate the number of points, presser foot, process beginning and end and return machine time as the effective sewing time; “Select_ProgProduction(US, processPoints, processPresserFoot, processTime)” means query database for production programming and return production programming code with programming having to be similar to points, presser foot and machine time; “Select_Tasks(US, processPoints, processPresserFoot, processtime)” means return code found for similar task, if none is found then a code is automatically generated; “generateTimeImproductive(US, processBeginning)” means query for improductive time, search for last history record generated and calculate time between it and the time informed in “processBeginning”, if the time is longer than 10 seconds a specific improductive time register is generated in the history; “generateHistory(US, processBeginning, processEnd, production Program med, taskidentified, processPoints, processPresserFoot, processTime, standardPoints, standardPresserFoot, standardTime, mHist_TRT, time_Improductive, efficiencyTimeStandard)” means generate history for the readings of the data informed, readings are excluded in order to prevent reprocessing, task or production programming are up-dated, so that for the next process they are included in the corrected average time; “searchElementsSeparation(US, elementEnd)” means search in ascending order for readings that have not been separated, return Sensor Unit and final element to be processed, the final element is identified as the first record for the existing presser foot.

1. “REMOTE MULTIPOINT MONITORING AND TIMELINE ANALYSIS EQUIPAMENT” is of the type traditionally manufactured on printed circuit boards, with PC (5), characterized by featuring a functional technical configuration comprised of four basic parts, that are the control unit (UC) (1), retransmission unit (HUB) (2), sensor unit (US) (3) and sensors(4).

2. “REMOTE MULTIPOINT MONITORING AND TIMELINE ANALYSIS EQUIPAMENT” according to claim 1 characterized by the control unit (1) comprised of, interactively, by micro-processed controller (1.1), crystal oscillator (1.1.1), crystal oscillator (1.1.2), 32 kbyte RAM memory (1.2), E2PROM memory (1.3), RS-485 serial interface driver (1.4), 5-volt voltage regulator (1.5), 3.3-volt voltage regulator (1.6), connector for display and liquid crystal LDC (1.7), real time clock RTC (1.8), battery (1.8.1), RS-232 interface connector (1.9), communication interface LEDs (1.10), and tact switches (1.11), expansion connector (1.12), RS-232 serial interface driver (1.13), and JTAG interface connector (1.14), 3.3-volt power source (1.15) and sound alarm (1.16).

3. “REMOTE MULTIPOINT MONITORING AND TIMELINE ANALYSIS EQUIPAMENTI” according to claim 1 characterized by the retransmission unit (2) has, interactively, an RS-485 serial interface driver (2.1), connector (2.1.1), voltage comparison device (2.1.2), UC to US communication direction controller (2.2), Us to UC communication direction controller (2.3), US communication indication LED circuit (2.4), RS-485 serial interface driver (2.5), connectors (2.5.1) and (2.5.2), single stable circuit (2.6), single stable (2.6.1), UC to US communication direction indication LEDs (2.6.2), 3.3 volt voltage regulator (2.7), integrated circuit uncoupling capacitors (2.8).

4. “REMOTE MULTIPOINT MONITORING AND TIMELINE ANALYSIS EQUIPAMENT” according to claim 1 characterized by a sensor unit (3) has, interactively, a micro-processed controller (3.1) with crystal oscillator (3.2), signal adapters (3.3.) with communication indication LEDs (3.3.1), E2PROM memory (3.4), RS-485 serial interface driver (3.5), connector RJ45PCI (3.5.1), connector for sensors (3.6), hardware expansion connector (3.7), load connector (3.8), additional source connector (3.9), reset circuit breaker (3.9.1), jumpers (3.10), 3.3 volt voltage regulator (3.11), two-color LED (3.12).

5. “REMOTE MULTIPOINT MONITORING AND TIMELINE ANALYSIS EQUIPAMENT” is of the type traditionally manufactured on printed circuit boards, characterized by featuring on board software programs that deliver: productivity reports detailed per operator, cells or plants, with number of parts produced; longer time, shorter time per operation, productive times, non-productive times, comparison of processes carried out by operators (movement and times studies); statistical forecast for product delivery dates, make up items programmed purchases, indication of most efficient lines (people with the same efficiencies), real time production line bottleneck forecasts, plant increase, balancing of production (distribution of work and positioning).

6. “REMOTE MULTIPOINT MONITORING AND TIMELINE ANALYSIS EQUIPAMENT” according to claims 1, 2, 3 and 4 characterized by having a control unit (1), retransmission unit (2), sensor unit (3) and sensors (4), featuring independent device characteristics, associated through management software, within a make up that forms a remote multipoint monitoring and timeline analysis unit.

7. “METHOD FOR REMOTE MULTIPOINT MONITORING AND TIMELINE ANALYSIS” according to claims 1, 2, 3, 4, 5, 6 is the method to carry out remote multipoint monitoring and timeline analysis, characterized for presenting a method of performing capture, treatment and display of information managed by the algorithm unit readings;
Control unit
It receives the commands sent by the serial door and it repasses them for the Sensory Units.
```
{
  Initial data:
    UC :Abbreviation of control unit.
    US :Abbreviation of sensory unit.
    P1 :Abbreviation Port 1.
    P2 :Abbreviation Port 2.
    P3 :Abbreviation Port 3.
      commandReceiveSerial : Used function to catch the data that
had been sent of the serial door of the computer for the UC.
This function does not have body, therefore they are interruptions
of the microcontroller and are fed by it.
      commandTransmitSerial : Used function to transmit the data
of the UC for the serial door of the computer. This function does not
have body, therefore they are interruptions of the microcontroller
and are fed by it.
      commandReceiveNetwork : Used function to catch the data
that had been sent of the net of the US for the UC. This function does
not have body, therefore they are interruptions of the microcontroller
and are fed by it.
      commandTransmitNetwork : Used function to transmit given
of the UC for net of the US. This function does not have body, therefore
they are interruptions of the microcontroller and are fed by it
      timeOut  : All transmission has a time of reply return,
if the time to finish  the  function  timeOut  will
be  called  by  the function commandTransmitNetwork.
}
var
    countErrors  : integer;
    countErrorsUC  : integer;
```

| | |
|---|---|
| ledTransmit | : string := ‘OFF’; |
| ledReceive | : string := ‘OFF’; |

```
  while true do
  begin
  case commandReceiveSerial do
  ‘startUC’:
      startUC( );
      break;
  ‘restartUS’:
      restartUS(sensora);
      break;
  ‘write1P1’:
      commandTransmitNetwork := commandReceiveSerial;
      break;
  ‘write0P1’:
        commandTransmitNetwork(commandReceiveSerial( ));
        break;
  ‘write1P2’:
        commandTransmitNetwork(commandReceiveSerial( ));
        break;
  ‘write0P2’:
        commandTransmitNetwork(commandReceiveSerial( ));
        break;
  ‘write1P3’:
        commandTransmitNetwork(commandReceiveSerial( ));
        break;
  ‘write0P3’:
        commandTransmitNetwork(commandReceiveSerial( ));
        break;
  ‘readCountP1’:
        commandTransmitNetwork(commandReceiveSerial( ));
        break;
  ‘readCountP2’:
        commandTransmitNetwork(commandReceiveSerial( ));
        break;
  ‘readCountP3’:
        commandTransmitNetwork(commandReceiveSerial( ));
        break;
  ‘configureP1Out’:
        commandTransmitNetwork(commandReceiveSerial( ));
        break;
  ‘configureP1In’:
        commandTransmitNetwork(commandReceiveSerial( ));
        break;
  ‘configureP2Out’:
        commandTransmitNetwork(commandReceiveSerial( ));
        break;
  ‘configureP2In’:
        commandTransmitNetwork(commandReceiveSerial( ));
        break;
  ‘configureP3Out’:
        commandTransmitNetwork(commandReceiveSerial( ));
        break;
  ‘configureP3In’:
        commandTransmitNetwork(commandReceiveSerial( ));
        break;
  ‘configureP1Up’:
        commandTransmitNetwork(commandReceiveSerial( ));
        break;
  ‘configureP1Down’:
        commandTransmitNetwork(commandReceiveSerial( ));
        break;
  ‘configureP2Up’:
        commandTransmitNetwork(commandReceiveSerial( ));
        break;
  ‘configureP2Down’:
        commandTransmitNetwork(commandReceiveSerial( ));
        break;
  ‘configureP3Up’:
        commandTransmitNetwork(commandReceiveSerial( ));
        break;
  ‘configureP3Down’:
        commandTransmitNetwork(commandReceiveSerial( ));
        break;
  ‘readCountErrors’:
        commandTransmitNetwork(commandReceiveSerial( ));
        break;
  ‘clearCountErrors’:
        commandTransmitNetwork(commandReceiveSerial( ));
        break;
  ‘readCountErrorsUC’:
        readCountErrorsUC;
        break;
  ‘clearCountErrorsUC’:
        clearCountErrorsUC;
        break;
  ‘onBlinkLeds’:
        commandTransmitNetwork(commandReceiveSerial( ));
        break;
  ‘offBlinkLeds’:
        commandTransmitNetwork(commandReceiveSerial( ));
        break;
  ‘ONLed1’:
        commandTransmitNetwork(commandReceiveSerial( ));
        break;
  ‘OFFLed1’:
        commandTransmitNetwork(commandReceiveSerial( ));
        break;
  ‘ONLed2’:
        commandTransmitNetwork(commandReceiveSerial( ));
        break;
  ‘OFFLed2’:
        commandTransmitNetwork(commandReceiveSerial( ));
        break;
  ‘specificPoll’:
        commandTransmitNetwork(commandReceiveSerial( ));
        break;
  ‘genericPoll’:
        commandTransmitNetwork(commandReceiveSerial( ));
        break;
  ‘readCountAllUS’:
        commandTransmitNetwork(commandReceiveSerial( ));
        break;
end;
//start UC
procedure startUC;
begin
  CountErrorsUC := 0;
  CountErrors := 0;
  blinkLedReceive;
  blinkLedTransmit;
  presentation;
end;
function commandTransmitSerial( );
function commandReceiveSerial( );
function commandTransmitNetworkUS( );
function commandReceiveNetworkUS( );
procedure blinkLedTransmit;
begin
  OnLedTransmit;
  OffLedTransmit;
end;
procedure blinkLedReceive;
begin
  ONLedReceive;
  OFFLedReceive;
end;
procedure OnLedTransmit;
begin
  ledTransmit := ‘ON’;
end;
procedure OffLedTransmit;
begin
  ledTransmit := ‘OFF’;
end;
procedure ONLedReceive;
begin
  ledReceive := ‘ON’;
end;
procedure OFFLedReceive;
begin
  ledReceive := ‘OFF’;
end;
procedure timeOut;
begin
  inc(CountErrors);
end;
procedure presentation;
begin
  commandTransmitSerial(‘SISTEMA DE MONITORAMENTO’);
  commandTransmitSerial(‘TS TECNOLOGIA E SISTEMA REV. 1.0’);
end;
procedure leCountErrorsUC;
begin
  commandTransmitNetwork(CountErrorsUC);
end;
procedure limpaCountErrorsUC;
begin
  commandTransmitNetwork(CountErrorsUC);
end;
```
Sensory Units
It receives the commands sent by the Control unit, treats the command and it returns the data for the Control unit
```
{
  Initial Data:
    UC :Abbreviation of control unit.
    US :Abbreviation of sensory unit.
    commandReceiveNetwork : Used function to catch the data that had
been sent of the net of the US for the UC. This function does not have
body, therefore  they  are  interruptions  of  the
microcontroller  and are fed by it.
    commandTransmitNetwork : Used function to transmit given of the
UC for net of the US. This function does not have body, therefore they
are interruptions of the microcontroller and are fed by it.
    interruptionSensorX : Functions to make the increment of the
accountants of sensor X (1, 2 or 3), they are interruptions of the
microcontroller.
When to occur an interruption returns a value boolean with current state
from the interruption true or falsifies;
    writeXPY : It writes Y (1 or 0) in door X (1, 2 or 3) when it will
be defined as exit.
}
//variables
var
countPort1 : integer;
countPort2 : integer;
countPort3 : integer;
```

| | |
|---|---|
| Port1 | : string := ‘ENTRADA’; |
| Port2 | : string := ‘ENTRADA’; |
| Port3 | : string := ‘ENTRADA’; |
| led1 | : string := ‘OFF’; |
| led2 | : string := ‘OFF’; |

//Constants of the system
const

| | |
|---|---|
| USid | : integer := 1; |

```
while true do
begin
  If US = USid then
  begin
    ‘find’:
      find(US);
      break;
    ‘write1P1’:
      if Port1 = ‘OUT’ then
        commandTransmitNetwork := commandReceiveSerial;
      else
        commandTransmitNetwork := ‘FAILURE’;
      break;
    ‘write0P1’:
      if Port1 = ‘OUT’ then
        commandTransmitNetwork(commandReceiveSerial( ));
      else
        commandTransmitNetwork := ‘FAILURE’;
      break;
    ‘write1P2’:
      if Port2 = ‘OUT’ then
        commandTransmitNetwork(commandReceiveSerial( ));
      else
        commandTransmitNetwork := ‘FAILURE’;
      break;
    ‘write0P2’:
      if Port2 = ‘OUT’ then
        commandTransmitNetwork(commandReceiveSerial( ));
      else
        commandTransmitNetwork := ‘FAILURE’;
      break;
    ‘write1P3’:
      ifPort3=‘OUT’then
        commandTransmitNetwork(commandReceiveSerial( ));
      else
            commandTransmitNetwork := ‘FAILURE’;
      break;
    ‘write0P3’:
      if Port3 = ‘OUT’ then
        commandTransmitNetwork(commandReceiveSerial( ));
      else
        commandTransmitNetwork := ‘FAILURE’;
      break;
    ‘readAllCounts’:
      readAllCounts;
      break;
    ’readCountP1’:
      readCountP1;
      break;
    ‘readCountP2’:
      readCountP2;
      break;
    ‘readCountP3’:
      read CountP3;
      break;
    ‘configureP1OUT’:
      configureP1OUT;
      break;
    ‘configureP1In’:
      configureP1In;
      break;
    ‘configureP2OUT’:
      configureP2OUT;
      break;
    ‘configureP2In’:
      configureP2In;
      break;
    ‘configureP3OUT’:
      configureP3OUT;
      break;
    ‘configureP3In’:
      configureP3In;
      break;
    ‘configureP1UP’:
      configureP1UP;
      break;
    ‘configureP1DOWN’:
      configureP1DOWN;
      break;
    ‘configureP2UP’:
      configureP2UP;
      break;
    ‘configureP2DOWN’:
      configureP2DOWN;
      break;
    ‘configureP3UP’:
      configureP3UP;
      break;
    ‘configureP3DOWN’:
      configureP3DOWN;
      break;
    ‘readCountErrors’:
      readCountErrors;
      break;
    ‘clearCountErrors’:
      clearCountErrors;
      break;
    ‘ONblinkLeds’:
      ONblinkLeds;
      break;
    ‘OFFblinkLeds’:
      OFFblinkLeds;
      break;
    ‘ONLed1’:
      ONLed1;
      break;
    ‘OFFLed1’:
      OFFLed1;
      break;
    ‘ONLed2’:
      ONLed2;
      break;
    ‘OFFLed2’:
      OFFLed2;
      break;
    //it develops the readings of the accountants of ports
    if interruptionSensor1( ) = true then
    begin
      countPort1 := countPort1 + 1;
    end;
    if interruptionSensor2( ) = true then
    begin
      countPort2 := countPort2 + 1;
    end;
    if interruptionSensor3( ) = true then
    begin
      countPort3 := countPort3 + 1;
    end;
  end;
end;
//interruptions of the ports
function interruptionSensor1( ) : boolean;
function interruptionSensor2( ) : boolean;
function interruptionSensor3( ) : boolean;
//functions of communication with the net
procedure commandTransmitNetworkUS;
procedure commandReceiveNetworkUS;
//write 0 or 1 in Ports
procedure write1P1;
procedure write0P1;
procedure write1P2;
procedure write0P2;
function write1P3;
function write0P3;
//Read Counts of ports
procedure readAllCounts;
begin
  commandTransmitNetworkUS(readCountP1( ));
  commandTransmitNetworkUS(readCountP2( ));
  commandTransmitNetworkUS(readCountP3( ));
end;
procedure readCountP1;
begin
  commandTransmitNetworkUS(countP1);
end;
procedure readCountP2;
begin
  commandTransmitNetworkUS(countP2);
end;
procedure readCountP3;
begin
  commandTransmitNetworkUS(countP3);
end;
// in/out configures the way of functioning of port
procedure configureP1OUT;
procedure configureP1In;
procedure configureP2OUT;
procedure configureP2In;
procedure configureP3OUT;
procedure configureP3In;
//edge of ascent or descending configures the way of detonation of port
procedure configureP1UP;
procedure configureP1DOWN;
procedure configureP2UP;
procedure configureP2DOWN;
procedure configureP3UP;
procedure configureP3DOWN;
//count Errors
procedure readCountErrors; // read count errors
begin
  commandTransmitNetworkUS(countErrors);
end;
procedure clearCountErrors; // clear count errors
begin
  countErrors := 0;
end;
//treatment of leds
procedure ONblinkLeds;
begin
  blinkLeds := ‘ON’;
  commandTransmitNetworkUS(‘OK’);
end;
procedure OFFblinkLeds;
begin
  blinkLeds := ‘OFF’;
  commandTransmitNetworkUS(‘OK’);
end;
procedure ONLed1;
begin
  led1 := ‘ON’;
  commandTransmitNetworkUS(‘OK’);
end;
procedure OFFLed1;
begin
  led1 := ‘OFF’;
  commandTransmitNetworkUS(‘OK’);
end;
procedure ONLed2;
begin
  led2 := ‘ON’;
  commandTransmitNetworkUS(‘OK’);
end;
procedure OFFLed2;
begin
  led2 := ‘OFF’;
  commandTransmitNetworkUS(‘OK’);
end;
procedure find;
begin
  commandTransmitNetworkUS(‘OK’);
end;
```
